(19) United States
(12) Patent Application Publication
(10) Pub. No.: US 2025/0029006 A1
(43) Pub. Date: Jan. 23, 2025

(54) OPERATION LEARNING SYSTEM, OPERATION IDENTIFYING SYSTEM, AND IDENTIFYING-DEVICE

(71) Applicant: Mitsubishi Electric Corporation, Chiyoda-ku, Tokyo (JP)

(72) Inventors: Tetsuya TAMAKI, Chiyoda-ku, Tokyo (JP); Toshiyuki HATTA, Chiyoda-ku, Tokyo (JP)

(73) Assignee: Mitsubishi Electric Corporation, Chiyoda-ku, Tokyo (JP)

(21) Appl. No.: 18/701,685

(22) PCT Filed: Nov. 4, 2022
(86) PCT No.: PCT/JP2022/041162

§ 371 Date: Apr. 16, 2024

(30) Foreign Application Priority Data
Nov. 9, 2021 (JP) 2021-182266

(51) Int. Cl. G06N 20/00

(52) U.S. Cl. CPC G06N 20/00

(57) ABSTRACT

An operation learning system includes a learning device, a location information generating device to generate location information indicating the location of an operator, a movement information generating device to generate movement information indicating the movement of the operator, an object information generating device to generate object information indicating the object handled by the operator, and an operation information generating device to generate operation information indicating an operation type of an operation performed by the operator. The learning device includes data acquiring circuity to acquire the location, movement, object, and operation information from the location information generating device, movement information generating device, object information generating device, and operation information generating device, and model generating circuitry to learn operation types of operations performed by the operator, using the location, movement, object, and operation information, and generate a learned model.

### TECHNICAL FIELD

The present disclosure relates to an operation learning system, an operation identifying system, a learning device, an identifying device, an operation learning method, an operation identifying method, and a program.

### BACKGROUND ART

Activities of operators in a manufacturing factory affect the productivity. The activities of the operators thus need to be recorded and analyzed.

For example, Patent Literature 1 discloses a position specifying system including wireless terminal devices held by monitoring targets, and sensor devices that take images of the monitoring targets through wireless communication with the wireless terminal devices. The wireless terminal devices in this position specifying system each transmit, to a sensor device, identification information peculiar to the wireless terminal device and a detection signal for detection of the position of the wireless terminal device. The sensor device detects the position of the wireless terminal device on the basis of the detection signal containing the received identification information, and calculates a position of the monitoring target on the basis of an image taken by an imager. The sensor device associates the calculated position of the monitoring target and the position and the identification information on the detected wireless terminal device, and thus specifies the position of the monitoring target.

### CITATION LIST

### Patent Literature

Patent Literature 1: Japanese Patent No. 5385893

### SUMMARY OF INVENTION

### Technical Problem

The system disclosed in Patent Literature 1 specifies the position of the monitoring target and just tracks the movements of the monitoring target. The system disclosed in Patent Literature 1 can be applied to a manufacturing factory, but cannot obtain operation information indicating the operation type of an operation being performed by the operator at this location. The operation information is essential to analyze the operation.

An objective of the present disclosure, which has been accomplished to solve the above problems, is to readily obtain location information indicating the location of an operator and operation information indicating the operation type of an operation being performed by the operator at this location.

### Solution to Problem

In order to achieve the above objective, an operation learning system according to the present disclosure includes a learning device, a location information generating device, a movement information generating device, an object information generating device, and an operation information generating device. The learning device learns an operation type of an operation being performed by an operator. The location information generating device generates location information indicating a location of the operator. The movement information generating device generates movement information indicating a movement of the operator. The object information generating device generates object information indicating an object being handled by the operator. The operation information generating device generates operation information indicating an operation type of an operation being performed by the operator. The learning device includes a data acquirer and a model generator. The data acquirer acquires the location information, the movement information, the object information, and the operation information respectively from the location information generating device, the movement information generating device, the object information generating device, and the operation information generating device. The model generator learns, based on the location information, the movement information, the object information, and the operation information that are acquired by the data acquirer, the operation type of the operation being performed by the operator, and generates a learned model.

### Advantageous Effects of Invention

The operation learning system according to the present disclosure generates a learned model. The learned model receives data generated by associating the location information indicating the location of the operator, the movement information indicating the movement of the operator, and the object information indicating the object being handled by the operator with each other, and then outputs the operation type of the operation being performed by the operator. The operation learning system can therefore readily obtain location information indicating the location of the operator and operation information indicating the operation type of the operation being performed by the operator at this location.

### BRIEF DESCRIPTION OF DRAWINGS

FIG. 1 illustrates an exemplary configuration of an operation learning system according to Embodiment 1;

FIG. 2 is a block diagram illustrating an exemplary functional configuration of a location information generating device according to Embodiment 1;

FIG. 3 is a block diagram illustrating an exemplary functional configuration of a movement information generating device according to Embodiment 1;

FIG. 4 is a diagram for describing a method of determining a movement of the operator according to Embodiment 1;

FIG. 5 is a block diagram illustrating an exemplary functional configuration of an object information generating device according to Embodiment 1;

FIG. 6A is a block diagram illustrating an exemplary functional configuration of an operation information generating device according to Embodiment 1;

FIG. 6B is a block diagram illustrating another exemplary functional configuration of the operation information generating device according to Embodiment 1;

FIG. 7 is a flowchart illustrating exemplary steps of a learning process according to Embodiment 1;

FIG. 8A illustrates an exemplary functional configuration of an identifying device of an operation identifying system according to Embodiment 2;

FIG. 8B illustrates another exemplary functional configuration of the identifying device of the operation identifying system according to Embodiment 2;

FIG. 9 is a flowchart illustrating exemplary steps of an identifying process according to Embodiment 2; and

FIG. 10 illustrates an exemplary hardware configuration of the learning device according to Embodiment 1 and the identifying device according to Embodiment 2.

### DESCRIPTION OF EMBODIMENTS

An operation learning system, an operation identifying system, a learning device, an identifying device, an operation learning method, an operation identifying method, and a program according to embodiments are described in detail below with reference to the accompanying drawings. In these drawings, the components identical or corresponding to each other are provided with the same reference symbol.

### Embodiment 1

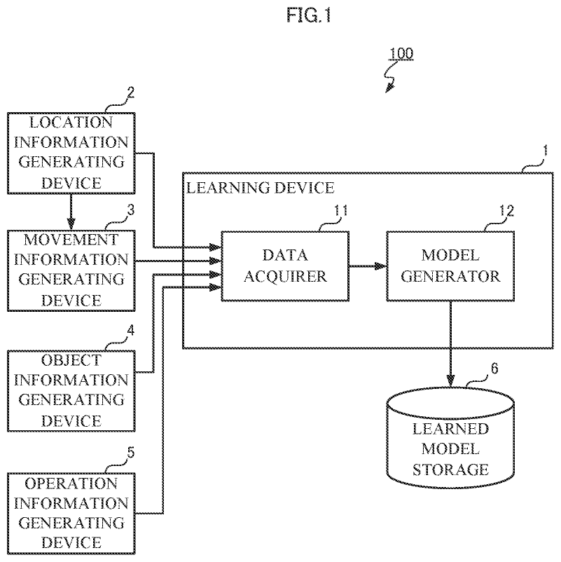

The following describes a configuration of an operation learning system 100 according to Embodiment 1 with reference to FIG. 1. The operation learning system 100 includes a learning device 1 that learns operation types of operations performed by an operator, a location information generating device 2 that generates location information indicating the location of the operator, a movement information generating device 3 that generates movement information indicating a movement of the operator, an object information generating device 4 that generates object information indicating the object being handled by the operator, and an operation information generating device 5 that generates operation information indicating the operation type of the operation being performed by the operator.

The learning device 1 includes a data acquirer 11 that acquires the location information, the movement information, the object information, and the operation information, and the model generator 12 that learns operation types of operations performed by the operator on the basis of the location information, the movement information, the object information, and the operation information, and generates a learned model. The model generator 12 generates pieces of learning data on the basis of the location information, the movement information, the object information, and the operation information acquired by the data acquirer 11, and learns operation types of operations performed by the operator by means of machine learning. After completion of the learning, the model generator 12 generates a learned model and stores the learned model into an external learned model storage 6. The learned model storage 6 may be included in the learning device 1.

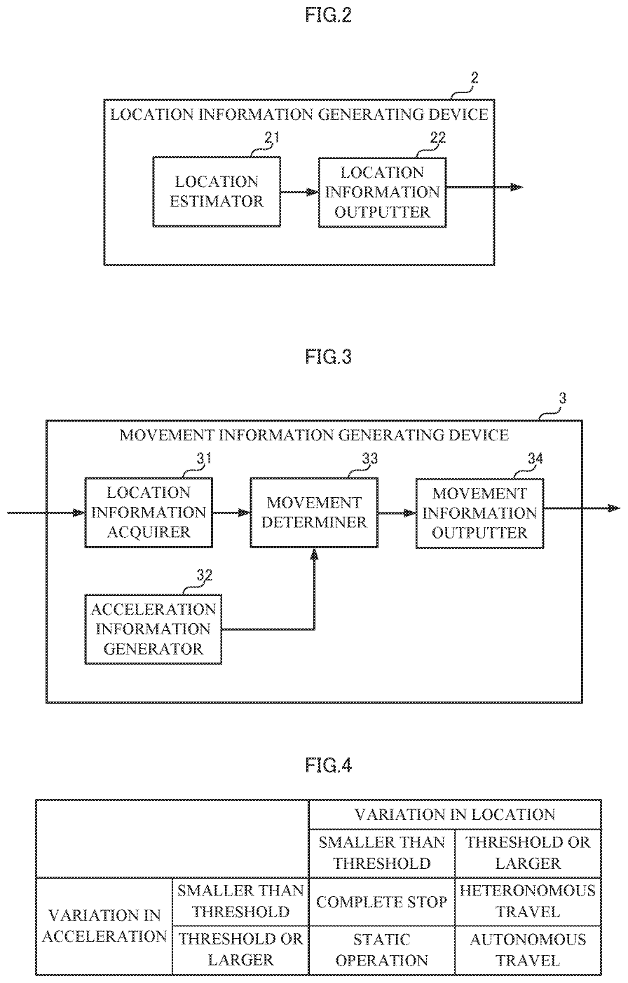

The location information generating device 2 has a functional configuration described below with reference to FIG. 2. The location information generating device 2 includes a location estimator 21 that estimates the location of the operator, and a location information outputter 22 that outputs pieces of location information. The location estimator 21 estimates the location of the operator by a procedure, examples of which include location estimation based on a positioning system, such as global positioning system (GPS), location estimation based on measurement using Bluetooth (registered trademark) signals or acoustic waves, and location estimation based on processing of images that capture the space around the operator. The location information outputter 22 generates pieces of location information in the chronological order each indicating the location of the operator estimated by the location estimator 21, and outputs the pieces of location information to the learning device 1 and the movement information generating device 3.

The movement information generating device 3 has a functional configuration described below with reference to FIG. 3. The movement information generating device 3 includes a location information acquirer 31 that acquires the pieces of location information from the location information generating device 2, an acceleration information generator 32 that generates pieces of acceleration information each indicating an acceleration of the operator, a movement determiner 33 that determines a movement of the operator, and a movement information outputter 34 that outputs pieces of movement information. The acceleration information generator 32 detects an acceleration of the operator using an accelerometer worn by the operator, for example. The acceleration information generator 32 then generates pieces of acceleration information in the chronological order each indicating the detected acceleration of the operator. The movement determiner 33 determines a movement of the operator, on the basis of the pieces of location information in the chronological order acquired by the location information acquirer 31 and on the basis of the pieces of acceleration information in the chronological order generated by the acceleration information generator 32.

The movement of the operator is determined by a procedure described below with reference to FIG. 4. The movement determiner 33 determines whether a variation in the location of the operator per unit time is at least a threshold, on the basis of the pieces of location information. The movement determiner 33 also determines whether a variation in the acceleration of the operator per unit time is at least a threshold, on the basis of the pieces of acceleration information.

As illustrated in FIG. 4, for a variation in the location of the operator per unit time smaller than the threshold and a variation in the acceleration of the operator per unit time smaller than the threshold, the movement determiner 33 determines the movement of the operator to be “complete stop”. The “complete stop” means that the operator is not traveling or performing an operation. For a variation in the location of the operator per unit time equal to or larger than the threshold and a variation in the acceleration of the operator per unit time smaller than the threshold, the movement determiner 33 determines the movement of the operator to be “heteronomous travel”. The “heteronomous travel” means that the operator is traveling without moving his or her body, for example, the operator is traveling on a vehicle, such as carrier cart or forklift. For a variation in the location of the operator per unit time smaller than the threshold and a variation in the acceleration of the operator per unit time equal to or larger than the threshold, the movement determiner 33 determines the movement of the operator to be “static operation”. The “static operation” means that the operator is performing an operation at the site without traveling. For a variation in the location of the operator per unit time equal to or larger than the threshold and a variation in the acceleration of the operator per unit time equal to or larger than the threshold, the movement determiner 33 determines the movement of the operator to be “autonomous travel”. The “autonomous travel” means that the operator is traveling by himself or herself.

The movement determiner 33 determines the movement of the operator to be any of the “complete stop”, “heteronomous travel”, “static operation”, and “autonomous travel” every unit time.

Referring back to FIG. 3, the movement information outputter 34 of the movement information generating device 3 generates pieces of movement information in the chronological order each indicating any of the “complete stop”, “heteronomous travel”, “static operation”, and “autonomous travel” as the movement of the operator, in accordance with results of determination at the movement determiner 33, and outputs the pieces of movement information to the learning device 1.

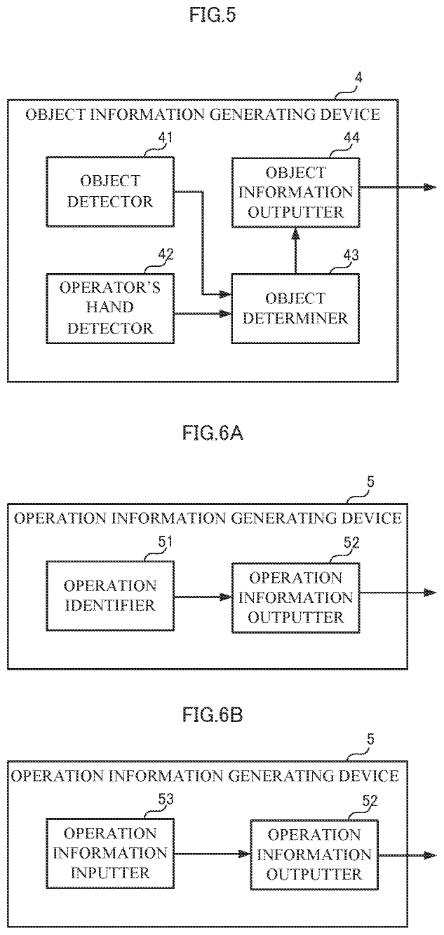

The object information generating device 4 has a functional configuration described below with reference to FIG. 5. The object information generating device 4 includes an object detector 41 that detects an object and its position, an operator's hand detector 42 that detects the hands of the operator and their positions, an object determiner 43 that determines the object being handled by the operator, and an object information outputter 44 that outputs pieces of object information.

The object detector 41 detects an object and its position by a procedure, examples of which include determination using a marker preliminarily provided to the object and estimation using AI on the basis of images taken by a camera worn by the operator. Examples of the object include a component, a material, and another operator necessary for the operation. The operator's hand detector 42 detects the hands of the operator and their positions by a procedure, examples of which include determination using markers preliminarily provided to the hands of the operator and detection of the skeleton of the hands of the operator on the basis of images taken by the camera worn by the operator. The object determiner 43 regards an object existing within a predetermined area around the hands of the operator as the object being handled by the operator, for example. Alternatively, the object determiner 43 may regard, as the object being handled by the operator, an object existing within the predetermined area around the hands of the operator and having been receiving the visual attention of the operator for at least a certain period on the basis of measurement of the visual attention of the operator.

The object information outputter 44 generates pieces of object information in the chronological order each indicating the object being handled by the operator in accordance with results of determination at the object determiner 43, and outputs the pieces of object information to the learning device 1.

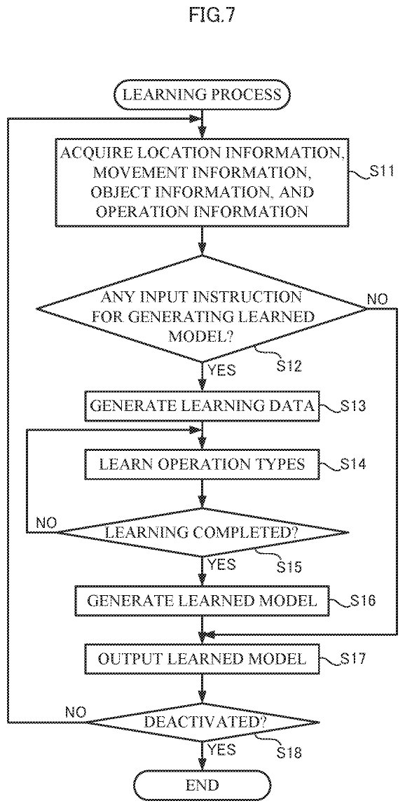

The operation information generating device 5 has a functional configuration described below with reference to FIGS. 6A and 6B. In the example illustrated in FIG. 6A, the operation information generating device 5 includes an operation identifier 51 that identifies the operation type of the operation being performed by the operator, and the operation information outputter 52 that outputs pieces of operation information.

For example, the operation identifier 51 processes images that capture the operator, and thus identifies the operation type of the performed operation by pattern matching. Alternatively, the operation identifier 51 may detect the skeleton of the operator from images that capture the operator, and identify the operation type of the operation being performed by the operator on the basis of the movement of the skeleton. The operation information outputter 52 generates pieces of operation information each indicating the operation type of the operation being performed by the operator in accordance with results of identification at the operation identifier 51, and outputs the pieces of operation information to the learning device 1. The pieces of operation information each contain time information indicating the period involving the times of capturing the images used to identify the operation type.

The above-described functional configuration of the operation information generating device 5 is a mere example. As illustrated in FIG. 6B, the operation information generating device 5 may include an operation information inputter 53 that receives the operation type and the period of the operation to be input, in place of the operation identifier 51. In this case, the operator inputs the operation type and the period of the own operation into the operation information inputter 53. The operation information outputter 52 generates pieces of operation information each indicating the operation type input to the operation information inputter 53, and outputs the pieces of operation information to the learning device 1. The pieces of operation information each contain time information indicating the period of the operation input into the operation information inputter 53. The operation type and the period of the operation may be input by a person other than the operator.

The operation information generating device 5 may include both of the operation identifier 51 and the operation information inputter 53. In this case, the priorities of the operation types to be used in generation of operation information at the operation information outputter 52 are preliminarily determined, among the operation type of the operation being performed by the operator in accordance with results of identification at the operation identifier 51 and the operation type input to the operation information inputter 53 when these operation types are different from each other.

Referring back to FIG. 1, the data acquirer 11 of the learning device 1 acquires the location information, the movement information, the object information, and the operation information respectively from the location information generating device 2, the movement information generating device 3, the object information generating device 4, and the operation information generating device 5. The model generator 12 learns operation types of operations performed by the operator on the basis of the location information, the movement information, the object information, and the operation information acquired by the data acquirer 11, and generates a learned model. The model generator 12 generates a learned model at a timing, examples of which include a timing of reception of an instruction for generating a learned model, a predetermined timing, or a timing when a certain period has elapsed since the start of acquisition of the location information, the movement information, the object information, and the operation information.

The operations are categorized into typical operation types and atypical operation types. Examples of the typical operation types include the following operation types (1) to (5): (1) a transportation from the point A to the point B in a warehouse along a predetermined route; (2) an operation at a fixed location in accordance with a predetermined procedure; (3) an operation during traveling in accordance with a predetermined procedure; (4) a predetermined face-to-face consultation; and (5) a combination of the operations (1) to (4). That is, the operations are categorized into six operation types including the typical operations (1) to (5) and an atypical operation (6) in this example. These operation types are mere examples. The operation types may also be the names of operations or the identification numbers for identifying operations, for example.

The model generator 12 uses a learning algorithm, examples of which include supervised learning algorithms, unsupervised learning algorithms, and reinforcement learning algorithms. The description focuses on an example in which the model generator 12 uses the K-means algorithm, which is a kind of unsupervised learning algorithms. The unsupervised learning algorithms are methods for learning characteristics of data without pre-existing results (labels). The K-means algorithm, which is a non-hierarchical clustering algorithm, is a method for classifying data into K clusters using the means of the clusters.

Specifically, the model generator 12 generates, for each of the pieces of operation information, a piece of learning data xi by associating the location information, the movement information, and the object information with each other that correspond to the period of the image capture or the period of the operation indicated by the time information contained in the piece of operation information. The piece of learning data xi is associated with the piece of operation information. The model generator 12 assigns the resulting pieces of learning data xi to K clusters at random. K is equal to 6 in the case where the operations are categorized into six operation types including the typical operations (1) to (5) and the atypical operation (6) as described above.

The model generator 12 calculates the centers Vj of the clusters to which the pieces of learning data xi are assigned. The model generator 12 then obtains the distances between each piece of learning data xi and the calculated centers Vj, and reassigns the piece of learning data xi to the cluster having the center Vj closest to the piece of learning data xi. When this reassignment step does not change the assignment of any of the pieces of learning data xi to the clusters or when the amount of change is smaller than a predetermined threshold, the model generator 12 finds convergence and completes the learning. The model generator 12 determines the operation type of which number is the largest among the operation types indicated by the pieces of operation information associated with the pieces of learning data xi assigned to each cluster, to be the operation type of this cluster. The operation types of the clusters are expected to have no overlap because operations involving similar locations and movements of the operator and similar objects belong to the same operation type.

The model generator 12 outputs the resulting learned model to the learned model storage 6. The learned model storage 6 stores the learned model output from the model generator 12. For example, the above-described learned model, which is prepared by learning of operation types of operations performed by the operator using the K-means algorithm, which is a kind of unsupervised learning algorithms, receives data generated by associating the location information, the movement information, and the object information with each other, determines the cluster to which the input data belongs (the cluster having the center Vj closest to the input data), and outputs the operation type of the determined cluster.

The steps of a learning process executed by the learning device 1 are described below with reference to FIG. 7. The learning process illustrated in FIG. 7 is started in response to activation of the learning device 1. The data acquirer 11 of the learning device 1 acquires the location information, the movement information, the object information, and the operation information respectively from the location information generating device 2, the movement information generating device 3, the object information generating device 4, and the operation information generating device 5 (Step S11). When no instruction for generating a learned model is input (Step S12; NO), the process goes to Step S18. In contrast, when an instruction for generating a learned model is input (Step S12; YES), the model generator 12 generates pieces of learning data on the basis of the location information, the movement information, the object information, and the operation information acquired by the data acquirer 11 (Step S13). In the case where the applied learning algorithm is the K-means algorithm, which is a kind of unsupervised learning algorithms, the model generator 12 in Step S13 generates pieces of learning data xi by associating the location information, the movement information, and the object information with each other that correspond to the period of the image capture or the period of the operation indicated by the time information contained in the pieces of operation information. The pieces of learning data xi are associated with the respective pieces of operation information.

The model generator 12 learns operation types of operations performed by the operator using the pieces of learning data (Step S14). In the case where the applied learning algorithm is the K-means algorithm, which is a kind of unsupervised learning algorithms, the model generator 12 in Step S14 assigns the pieces of learning data xi to the clusters at random. The model generator 12 calculates the centers Vj of the clusters to which the pieces of learning data xi are assigned. The model generator 12 then obtains the distances between each piece of learning data xi and the calculated centers Vj, and reassigns the piece of learning data xi to the cluster having the center Vj closest to the piece of learning data xi.

When the learning has not been completed (Step S15; NO), the process returns to Step S14 and repeats Steps S14 and S15. In contrast, when the learning has been completed (Step S15; YES), the model generator 12 generates a learned model (Step S16). In the case where the applied learning algorithm is the K-means algorithm, which is a kind of unsupervised learning algorithms, the model generator 12 in Step S15 determines completion of the learning when the reassignment step does not change the assignment of any of the pieces of learning data xi to the clusters or when the amount of change is smaller than the predetermined threshold. The model generator 12 then determines the operation type of which number is the largest among the operation types indicated by the pieces of operation information associated with the pieces of learning data xi assigned to each cluster, to be the operation type of this cluster. The model generator 12 in Step S16 generates a learned model, which receives data generated by associating the location information, the movement information, and the object information with each other, determines the cluster to which the input data belongs (the cluster having the center Vj closest to the input data), and outputs the operation type of the determined cluster.

The model generator 12 outputs the resulting learned model to the learned model storage 6 (Step S17). When the learning device 1 is not deactivated (Step S18; NO), the process returns to Step S11 and repeats Steps S11 to S18. In contrast, when the learning device 1 is deactivated (Step S18; YES), the process is terminated. Step S12 is not necessarily the determination of whether to receive an input instruction for generating a learned model. For example, Step S12 may be the determination of whether the current time corresponds to a predetermined timing for generating a learned model, or the determination of whether a certain period has elapsed since the start of acquisition of the location information, the movement information, the object information, and the operation information. Steps S11 to S16 are an exemplary operation learning method.

The operation learning system 100 according to Embodiment 1 generates a learned model. The learned model receives data generated by associating the location information indicating the location of the operator, the movement information indicating the movement of the operator, and the object information indicating the object being handled by the operator with each other, and then outputs the operation type of the operation being performed by the operator. The operation learning system 100 can therefore readily obtain the location information indicating the location of the operator and the operation information indicating the operation type of the operation being performed by the operator at this location.

### Embodiment 2

A system according to Embodiment 2 uses the learned model generated by the operation learning system 100 according to Embodiment 1 to identify the operation type of the operation being performed by an operator on the basis of location information, movement information, and object information, and then outputs operation information.

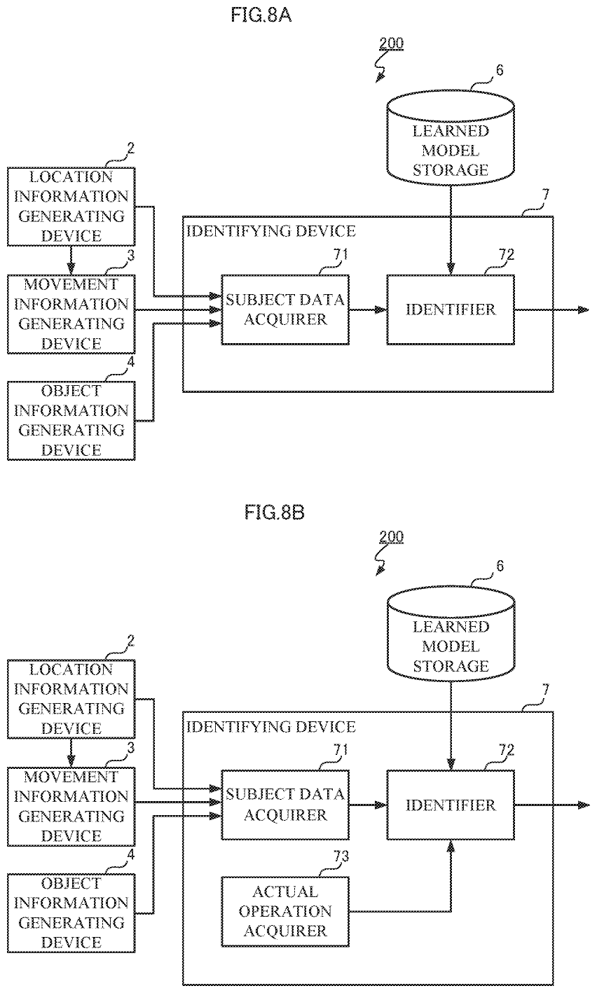

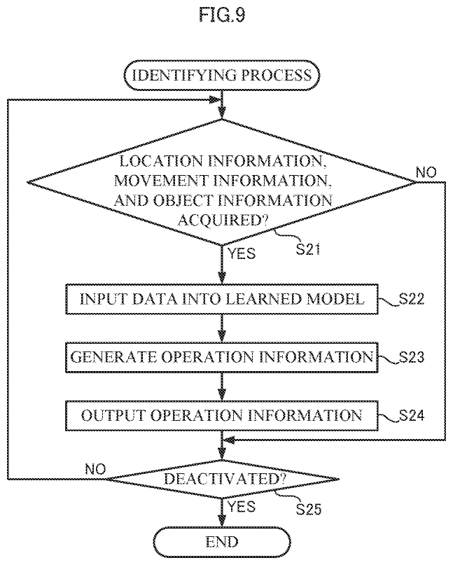

The following describes a configuration of an operation identifying system 200 according to Embodiment 2 with reference to FIGS. 8A and 8B. In the example illustrated in FIG. 8A, the operation identifying system 200 includes a location information generating device 2, a movement information generating device 3, an object information generating device 4, and an identifying device 7 that identifies the operation being performed by the operator and outputs operation information. The location information generating device 2, the movement information generating device 3, and the object information generating device 4 have the functional configurations identical to those in Embodiment 1. The identifying device 7 includes a subject data acquirer 71 that acquires location information, movement information, and object information on the operation type of the operation being performed by the operator to be subject to identification, and an identifier 72 that inputs data generated by associating the location information, the movement information, and the object information with each other into the learned model and identifies the operation type of the operation being performed by the operator.

The subject data acquirer 71 acquires the location information, the movement information, and the object information respectively from the location information generating device 2, the movement information generating device 3, and the object information generating device 4. The identifier 72 inputs data generated by associating the location information, the movement information, and the object information acquired by the subject data acquirer 71 with each other into the learned model stored in the learned model storage 6, generates operation information indicating the operation type of the operation being performed by the operator, in accordance with the operation type output from the learned model, and outputs the generated operation information. The operation information may be output in the form of a screen or sounds or transmitted to a terminal carried or worn by the operator. The learned model storage 6 may be included in the identifying device 7.

In the example illustrated in FIG. 8B, the identifying device 7 further includes an actual operation acquirer 73 that acquires actual operation information indicating the operation type of the operation actually performed by the operator. The actual operation acquirer 73 may acquire the actual operation information by receiving the information input by the operator, receiving the information from the terminal used by the operator, or acquiring the information from an external system or apparatus, for example. The identifier 72 feeds the actual operation information acquired by the actual operation acquirer 73 back to the learned model.

Specifically, the identifier 72 determines whether the operation type output from the learned model is correct, on the basis of the actual operation information. When the output operation type is incorrect, the identifier 72 uses the same learning algorithm as that used by the model generator 12 to generate a piece of learning data on the basis of the location information, the movement information, and the object information on the operation of which the operation type is misidentified, and on the basis of the actual operation information indicating the operation type of the actually performed operation, relearns operation types of operations performed by the operator, and updates the learned model. In an exemplary case of applying the K-means algorithm, the identifier 72 generates a piece of learning data xi on the basis of the location information, the movement information, and the object information on the operation of which the operation type is misidentified, and assigns the piece of learning data xi to the cluster corresponding to the operation type of the actually performed operation indicated by the actual operation information. The identifier 72 recalculates the centers Vj of the clusters, and reassigns each of the pieces of learning data xi to the cluster having the center Vj closest to the piece of learning data xi. The identifier 72, after completion of the learning, determines the operation type of which number is the largest among the operation types indicated by the pieces of operation information associated with the pieces of learning data xi assigned to each cluster, to be the operation type of this cluster. The identifier 72 thus updates the learned model.

The steps of an identifying process executed by the identifying device 7 are described below with reference to FIG. 9. The identifying process illustrated in FIG. 9 is started in response to activation of the identifying device 7. When the subject data acquirer 71 of the identifying device 7 does not acquire the location information, the movement information, and the object information respectively from the location information generating device 2, the movement information generating device 3, and the object information generating device 4 (Step S21; NO), the process goes to Step S25. In contrast, when the subject data acquirer 71 acquires the location information, the movement information, and the object information respectively from the location information generating device 2, the movement information generating device 3, and the object information generating device 4 (Step S21; YES), the identifier 72 inputs data generated by associating the location information, the movement information, and the object information acquired by the subject data acquirer 71 with each other, into the learned model stored in the learned model storage 6 (Step S22). The identifier 72 then generates operation information indicating the operation type of the operation being performed by the operator, in accordance with the operation type output from the learned model (Step S23), and outputs the generated operation information (Step S24).

When the identifying device 7 is not deactivated (Step S25; NO), the process returns to Step S21 and repeats Steps S21 to S25. In contrast, when the identifying device 7 is deactivated (Step S25; YES), the process is terminated. Steps S21 to S23 are an exemplary operation learning method.

The operation identifying system 200 according to Embodiment 2 uses a learned model. The learned model receives data generated by associating the location information indicating the location of the operator, the movement information indicating the movement of the operator, and the object information indicating the object being handled by the operator with each other, and then outputs the operation type of the operation being performed by the operator. The operation identifying system 200 can therefore readily obtain the location information indicating the location of the operator and the operation information indicating the operation type of the operation being performed by the operator at this location. The operation identifying system 200 also allows an administrator to observe the output operation information, recognize any abnormality in the quality, productivity, or work period of the production activity, and find room for improvement in the quality, productivity, or work period. These effects lead to improvement of the quality, productivity, or work period. In addition, the identifier 72 generates a piece of learning data on the basis of the location information, the movement information, and the object information on the operation of which the operation type is misidentified and on the basis of the actual operation information indicating the operation type of the actually performed operation, relearns operation types of operations performed by the operator, and thus updates the learned model. This configuration is expected to increase the accuracy of identification of the operation type in the learned model.

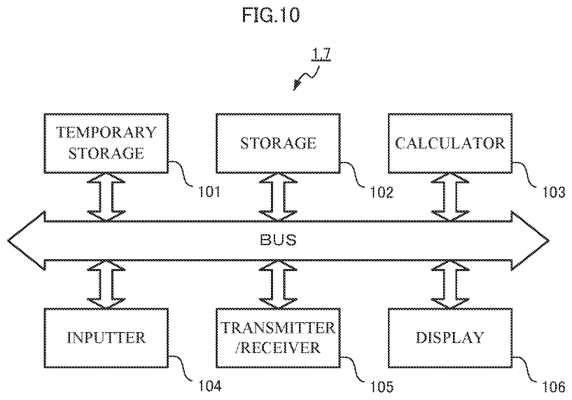

The learning device 1 and the identifying device 7 each have a hardware configuration described below with reference to FIG. 10. As illustrated in FIG. 10, the learning device 1 and the identifying device 7 each include a temporary storage 101, a storage 102, a calculator 103, an inputter 104, a transmitter/receiver 105, and a display 106. The temporary storage 101, the storage 102, the inputter 104, the transmitter/receiver 105, and the display 106 are each connected to the calculator 103 via buses.

The calculator 103 is a central processing unit (CPU), for example. The calculator 103 executes the processes of the model generator 12 or the identifier 72 in accordance with a control program stored in the storage 102.

The temporary storage 101 is a random access memory (RAM), for example. The temporary storage 101 receives the control program loaded from the storage 102. The temporary storage 101 serves as a work area of the calculator 103.

The storage 102 is a non-volatile memory, such as flash memory, hard disk, digital versatile disc-random access memory (DVD-RAM), or digital versatile disc-rewritable (DVD-RW). The storage 102 preliminarily stores the program for causing the calculator 103 to execute the processes of the learning device 1 or the identifying device 7. The storage 102 provides the calculator 103 with data contained in the program and stores data provided from the calculator 103, under the instruction from the calculator 103. The storage 102 serves as the learned model storage 6, in the learning device 1 or the identifying device 7 including the learned model storage 6.

The inputter 104 includes an input device, such as keyboard, pointing device, or audio input device, and an interface device for connecting the input device to the buses. The inputter 104 allows information input by a user to be provided to the calculator 103. The inputter 104 serves as the model generator 12, in the case where the model generator 12 receives an input instruction for generating a learned model.

The transmitter/receiver 105 includes a network termination device or wireless communication device connected to a network, and a serial interface or local area network (LAN) interface connected to this device. The transmitter/receiver 105 serves as the data acquirer 11 or the subject data acquirer 71.

The display 106 is a display device, such as liquid crystal display (LCD) or organic electroluminescence (EL) display. The display 106 serves as the identifier 72 in the case where the identifier 72 outputs the operation information in the form of a screen.

The processes of the data acquirer 11 and the model generator 12 of the learning device 1 illustrated in FIG. 1, the subject data acquirer 71 and the identifier 72 of the identifying device 7 illustrated in FIG. 8A, and the actual operation acquirer 73 of the identifying device 7 illustrated in FIG. 8B are achieved by the control program, using resources including the temporary storage 101, the calculator 103, the storage 102, the inputter 104, the transmitter/receiver 105, and the display 106.

The hardware configurations and the flowcharts described above are mere examples and may be modified and corrected in any manner.

The central part of execution of the processes at the learning device 1 or the identifying device 7, including the calculator 103, the temporary storage 101, the storage 102, the inputter 104, the transmitter/receiver 105, and the display 106, may be achieved by an ordinary computer system without a dedicated system. For example, a computer program for performing the above-described functions may be stored in a non-transitory computer-readable recording medium, such as flexible disk, compact disc-read only memory (CD-ROM), or digital versatile disc-read only memory (DVD-ROM), and distributed. This computer program may be installed in a computer to configure the learning device 1 or the identifying device 7 that executes the above processes. Alternatively, the computer program may be stored in a storage device included in a server on a communication network, such as the Internet, and may be downloaded into an ordinary computer system to configure the learning device 1 or the identifying device 7.

In the case where the functions of the learning device 1 or the identifying device 7 are achieved by sharing of an operating system (OS) and an application program or by cooperation of the OS and the application program, only the application program may be stored in a non-transitory recording medium or a storage device.

The computer program may be provided via a communication network while being superimposed on a carrier wave. For example, the computer program may be posted on a bulletin board system (BBS) on a communication network and may be provided via the network. A computer may activate this computer program and execute the computer program under the control of the OS in the same manner as the other application programs, and thereby execute the above processes.

The model generator 12 learns operation types of operations performed by the operator on the basis of the location information, the movement information, the object information, and the operation information acquired by the data acquirer 11, and generates a learned model in Embodiment 1 described above. This configuration is, however, a mere example. The model generator 12 may learn operation types of operations performed by the operator on the basis of a part of the location information, the movement information, and the object information acquired by the data acquirer 11, and generate a learned model, provided that the model generator 12 is able to learn operation types of operations performed by the operator.

The identifier 72 inputs data generated by associating the location information, the movement information, and the object information acquired by the subject data acquirer 71 with each other, into the learned model stored in the learned model storage 6, and generates operation information indicating the operation type of the operation being performed by the operator, in accordance with the operation type output from the learned model, in Embodiment 2 described above. This configuration is, however, a mere example. The identifier 72 may input data generated by associating a part of the location information, the movement information, and the object information acquired by the subject data acquirer 71 with each other, into the learned model stored in the learned model storage 6, and generate operation information indicating the operation type of the operation being performed by the operator, in accordance with the operation type output from the learned model, provided that the learned model is able to find the cluster to which the data is assigned.

Although the unsupervised learning based on the learning algorithm used by the model generator 12 is the non-hierarchical clustering based on the K-means algorithm in the specific examples in the above-described embodiments, this configuration is a mere example. Another example of the applicable unsupervised learning is the hierarchical clustering based on the nearest neighbor method. The unsupervised learning may be replaced with reinforcement learning, supervised learning, semi-supervised learning, or deep learning, for example. The same holds true for the machine learning in the identifier 72, which relearns operation types of operations performed by the operator and updates the learned model.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2021-182266, filed on Nov. 9, 2021, the entire disclosure of which is incorporated by reference herein.

### REFERENCE SIGNS LIST

1 Learning device

2 Location information generating device
3 Movement information generating device
4 Object information generating device
5 Operation information generating device
6 Learned model storage
7 Identifying device
11 Data acquirer
12 Model generator
21 Location estimator
22 Location information outputter
31 Location information acquirer
32 Acceleration information generator
33 Movement determiner
34 Movement information outputter
41 Object detector
42 Operator's hand detector
43 Object determiner
44 Object information outputter
51 Operation identifier
52 Operation information outputter
53 Operation information inputter
71 Subject data acquirer

### 72 Identifier

73 Actual operation acquirer
100 Operation learning system
101 Temporary storage

### 102 Storage

### 103 Calculator

### 104 Inputter

### 105 Transmitter/receiver

### 106 Display

200 Operation identifying system

1. An operation learning system comprising:
a learning device to learn an operation type of an operation being performed by an operator;
a location information generating device to generate location information indicating a location of the operator;
a movement information generating device to generate movement information indicating a movement of the operator;
an object information generating device to generate object information indicating an object being handled by the operator; and
an operation information generating device to generate operation information indicating an operation type of an operation being performed by the operator, wherein
the learning device includes
acquiring circuitry to acquire the location information, the movement information, the object information, and the operation information respectively from the location information generating device, the movement information generating device, the object information generating device, and the operation information generating device, and
model generating circuitry
to learn, based on the location information, the movement information, the object information, and the operation information that are acquired by the data acquiring circuitry, the operation type of the operation being performed by the operator, and
to generate a learned model, and
the operation type includes a typical operation of which operation is predetermined and an atypical operation of which operation is not predetermined.

2. An operation identifying system comprising:
an identifying device to identify an operation type of an operation being performed by an operator;
a location information generating device to generate location information indicating a location of the operator;
a movement information generating device to generate movement information indicating a movement of the operator; and
an object information generating device to generate object information indicating an object being handled by the operator, wherein
the identifying device includes
subject acquiring circuitry to acquire the location information, the movement information, and the object information respectively from the location information generating device, the movement information generating device, and the object information generating device, and
identifying circuitry
to input data into a learned model prepared by learning of operation types of operations performed by the operator, the data being generated by associating the location information, the movement information, and the object information that are acquired by the subject data acquiring circuitry with each other, and
to generate operation information indicating an operation type of an operation being performed by the operator, the operation type being output from the learned model, and
the operation type includes a typical operation of which operation is predetermined and an atypical operation of which operation is not predetermined.

3. (canceled)

4. An identifying device to identify an operation type of an operation being performed by an operator, the identifying device comprising:
subject data acquiring circuitry to acquire location information indicating a location of the operator, movement information indicating a movement of the operator, and object information indicating an object being handled by the operator; and
identifying circuitry
to input data into a learned model prepared by learning of operation types of operations performed by the operator, the data being generated by associating the location information, the movement information, and the object information that are acquired by the subject data acquiring circuitry with each other, and
to generate operation information indicating an operation type of an operation being performed by the operator, the operation type being output from the learned model, wherein
the operation type includes a typical operation of which operation is predetermined and an atypical operation of which operation is not predetermined.

5. The identifying device according to claim 4, further comprising:
actual operation acquiring circuitry to acquire actual operation information indicating an operation type of an actually performed operation actually performed by the operator, wherein
the identifying circuitry determines, based on the actual operation information, whether the operation type of the operation being performed by the operator output from the learned model is correct, and
when the operation type is incorrect, the identifying circuitry
relearns an operation type of the operation being performed by the operator, based on the location information, the movement information, and the object information on the operation of which the operation type is misidentified, and based on the actual operation information indicating the operation type of the actually performed operation, and
updates the learned model.

6. (canceled)

7. (canceled)

8. (canceled)

9. (canceled)
